(19) United States
(12) Patent Application Publication
(10) Pub. No.: US 2026/0346667 A1
(43) Pub. Date: Nov. 5, 2026

(54) SUSPENSION SUPPORT FOR VEHICLES INCLUDING REINFORCING ELEMENTS, AND SUSPENSION SYSTEM EQUIPPED WITH SUCH A SUPPORT

(71) Applicant: FLEXIS, BOULOGNE-BILLANCOURT (FR)

(72) Inventor: Christian DELORD, VILLIERS-SAINT-FREDERIC (FR)

(21) Appl. No.: 19/662,498

(22) Filed: Apr. 29, 2026

(30) Foreign Application Priority Data
Apr. 30, 2025 (FR) FR2504621

(51) Int. Cl. B60G 7/00

(52) U.S. Cl. CPC B60G 7/001; B60G 2200/144; B60G 2202/312; B60G 2204/43

(57) ABSTRACT

A suspension support for a motor vehicle includes: a cup that is intended for the upper fastening of a shock absorber along a main suspension axis, a main semi-cylindrical axial wall that is capped by the cup, a front peripheral reinforcement wall that is fastened on a front portion of the convex face of the main axial wall so as to form a front intermediate space suitable for receiving a front pivot for an upper suspension arm, a rear peripheral reinforcement wall that is fastened on a rear portion of the convex face of the main axial wall so as to form a rear intermediate space suitable for receiving a rear pivot for the upper suspension arm.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a suspension support for a motor vehicle. The present disclosure also relates to a suspension system and the vehicle equipped therewith.

### BACKGROUND

Various solutions are known for mounting a suspension, in particular in the front part of a motor vehicle.

When the vehicle is to be equipped with a double-wishbone suspension, it is necessary for the suspension support to have a certain rigidity in order to withstand the loads. This is particularly the case when the vehicle is a utility vehicle that must be able to carry relatively heavy loads.

Reinforced suspension supports for mounting a double-wishbone suspension are already known. However, existing solutions are not always suited to the specific constraints of certain vehicles.

### SUMMARY

An aim of the present disclosure is therefore to propose a suspension support that is sufficiently rigid to withstand high load constraints, while being easy to manufacture and assemble.

To this end, the present disclosure relates to a suspension support for a motor vehicle, the support including:
a cup that is intended for the upper fastening of a shock absorber along a main suspension axis,
a main semi-cylindrical axial wall that is capped by the cup,
a front peripheral reinforcement wall that is fastened on a front portion of the convex face of the main axial wall so as to form a front intermediate space suitable for receiving a front pivot for an upper suspension arm,
a rear peripheral reinforcement wall that is fastened on a rear portion of the convex face of the main axial wall so as to form a rear intermediate space suitable for receiving a rear pivot for the upper suspension arm.

The suspension support according to the present disclosure makes it possible to obtain optimal performance, in particular in terms of dynamic stiffness and durability, which makes it possible to limit the transmission of vibrations in the vehicle, and which reduces the noise generated by these vibrations. The suspension is capable of withstanding high loads, in particular when the vehicle is loaded, while ensuring sound vehicle behavior and good comfort.

The production of the suspension support according to the present disclosure is easy to implement, without having to use expensive and/or complex parts. The integration of this suspension support in the vehicle is relatively simple since it does not require deeply modifying the vehicle structure compared with a standard vehicle.

According to other advantageous aspects of the present disclosure, the suspension support comprises one or more of the following features, taken alone or according to all technically possible combinations:
the main axial wall includes two opposite longitudinal flanges each provided with a window communicating with the associated intermediate space so as to allow an element of the upper suspension arm to pass through said window;
each peripheral reinforcement wall includes a fastening portion that is pressed against the inner face of the associated longitudinal flange of the main axial wall;
the two peripheral reinforcement walls include an overlap portion where one of the peripheral reinforcement walls is fastened on the other peripheral reinforcement wall;
each peripheral reinforcement wall includes a portion whose profile, in an axial plane, has overall the shape of an omega, the associated intermediate space being formed inside the omega;
each peripheral reinforcement wall includes at least one stiffening rib that extends circumferentially relative to the main axial wall;
The present disclosure also proposes a motor-vehicle suspension system including:
a suspension support accordingly to any of the preceding features,
an upper suspension arm that includes a front pivot mounted in the front intermediate space and a rear pivot mounted in the rear intermediate space, each pivot being held on one side on the peripheral reinforcement wall and on the other side on the main axial wall,
a lower suspension arm,
a shock absorber whose upper end is fastened to the cup.

The present disclosure also proposes a motor vehicle comprising a suspension system according to the preceding features, characterized in that the main axial wall includes two opposite longitudinal flanges each provided with a window communicating with the associated intermediate space so as to allow an element of the upper suspension arm to pass through said window, and the lower end edge of each longitudinal flange extends in a plane substantially flush with the outer wall of a side member of the motor vehicle.

### BRIEF DESCRIPTION OF THE DRAWINGS

The present disclosure will appear more clearly on reading the following description, given solely by way of non-limiting example, and made with reference to the drawings wherein:

FIG. 1 is a diagram illustrating a motor vehicle equipped with a front suspension system;

FIG. 2 is a front view partially showing the front left part of the vehicle from FIG. 1 comprising a double-wishbone suspension system and a suspension support in accordance with the teachings of the present disclosure;

FIG. 3 is an exploded perspective view showing the main elements of the suspension support from FIG. 2;

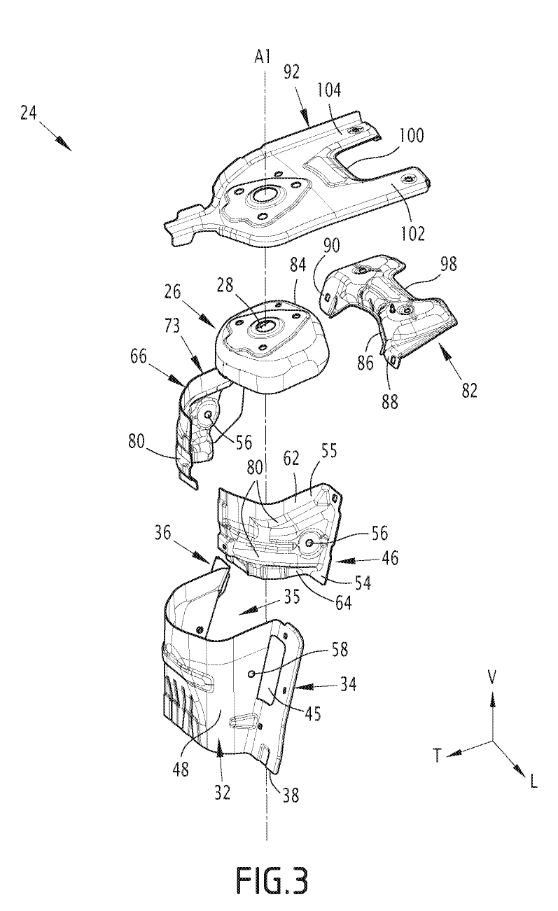

FIG. 4 is a transverse sectional view along plane IV-IV shown in FIG. 6 showing the mounting of the upper suspension arm on the suspension support shown in FIG. 2;

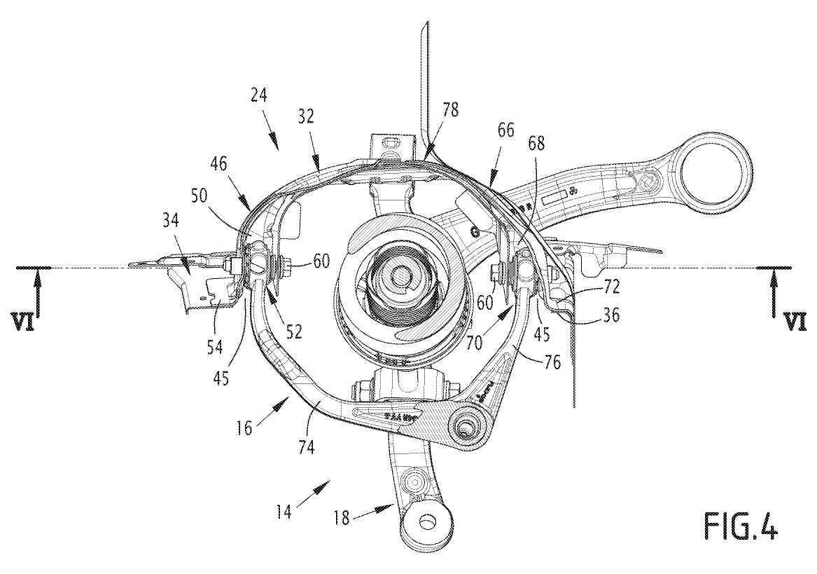

FIG. 5 is a transverse axial sectional view along plane V-V from FIG. 6 showing the main elements of the suspension support from FIG. 2, without the suspension system;

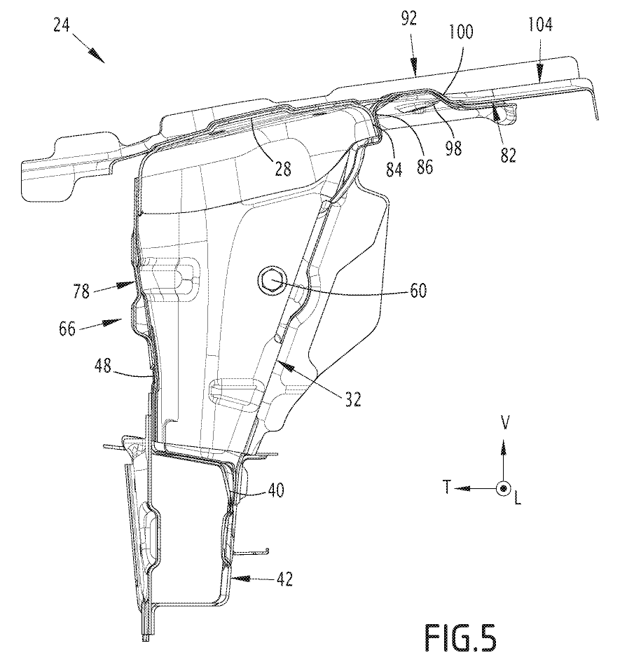

FIG. 6 is a longitudinal axial sectional view along plane VI-VI of FIG. 4 showing part of the suspension system from FIG. 2 with the pivots of its upper suspension arm mounted on the suspension support.

### DETAILED DESCRIPTION

In the remainder of the description, identical or similar elements will in some cases be designated by the same reference numerals.

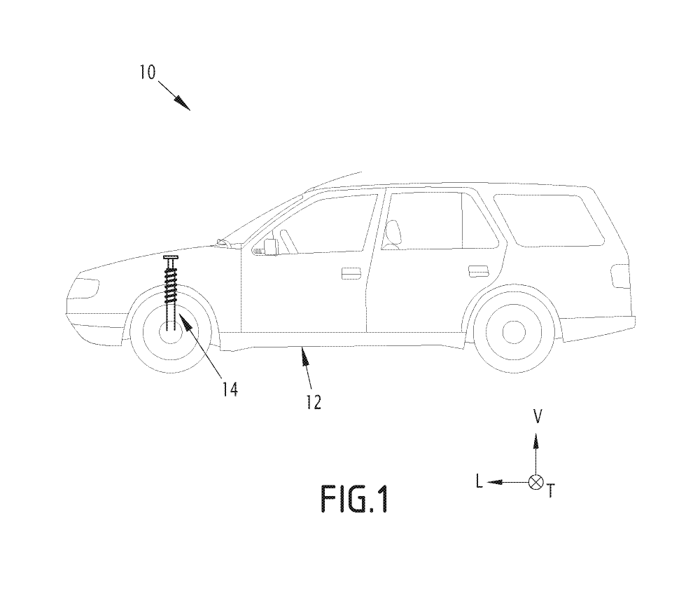

In FIG. 1, a vehicle 10, such as a utility motor vehicle, in particular a van, is shown schematically.

In the remainder of the description, a non-limiting orientation will be used according to a frame of reference V, L, T shown in the figures, corresponding to vertical V, longitudinal L, and transverse T directions, the longitudinal direction L corresponding to the general orientation of the vehicle 10. The longitudinal direction L is here oriented from rear to front, which corresponds to an orientation from right to left when considering FIG. 1.

The transverse direction T is here oriented from the outside to the inside of the vehicle 10, from right to left when considering FIG. 1.

According to the illustrated embodiment, the vehicle 10 includes a body 12 formed in particular of stamped sheet-metal elements assembled on one another. These stamped sheet-metal elements are for example welded to one another. Rivets and/or adhesive may also be used for this assembly.

The vehicle 10 includes, for each wheel, a suspension system 14.

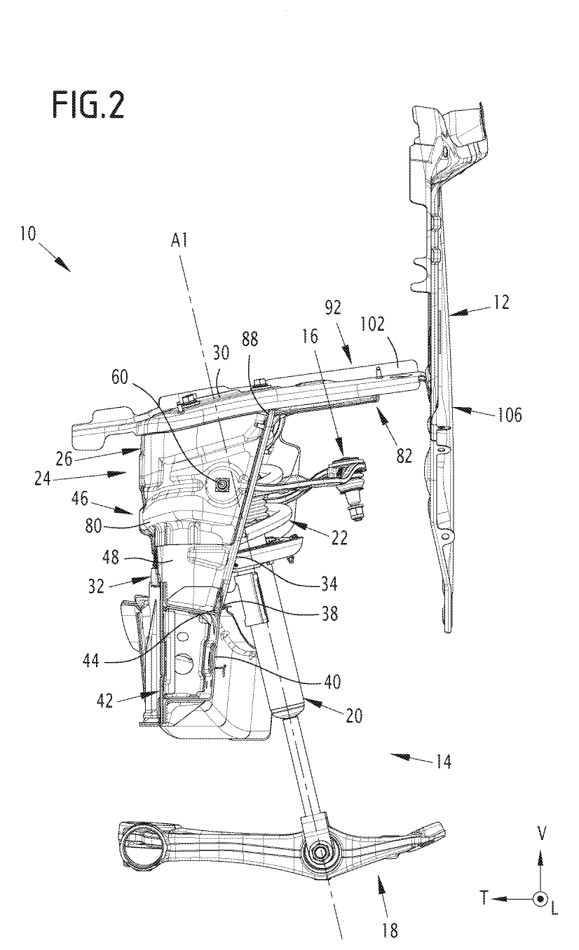

The suspension system 14 arranged at the front and on the left of the vehicle 10 is now described in more detail, considering in particular FIGS. 2 - 6. The suspension system 14 includes an upper suspension arm 16, a lower suspension arm 18, a telescopic shock absorber 20, and a coil spring 22.

By way of non-limiting example, an axial suspension direction A1 is defined along the main axis of the shock absorber 20 and of the coil spring 22.

Of course, the front right suspension system is identical to the front left suspension system 14, considering a longitudinal plane of symmetry.

The vehicle 10 includes a suspension support 24 that makes it possible to mount the suspension system 14 on the body 12.

The suspension support 24 includes a cup 26 that is intended for the upper fastening of the shock absorber 20. The cup 26 includes in particular a main orifice 28 into which the upper axial end 30 of the shock absorber 20 is screwed.

The suspension support 24 includes a main semi-cylindrical axial wall 32 that is capped by the cup 26. The cup 26 is, for example, welded to the upper edge 33 of the main axial wall 32.

The main axial wall 32 defines a gutter-shaped housing 35, along the axial suspension direction A1, which partially surrounds the shock absorber 20 and the coil spring 22, on the inner side of the vehicle 10.

The main axial wall 32 is extended here by two opposite longitudinal flanges 34, 36. Each longitudinal flange 34, 36 extends here in a plane slightly inclined relative to a longitudinal vertical plane.

Advantageously, the lower end edge 38 of each longitudinal flange 34, 36 is positioned near the outer wall 40 of a side member 42 of the vehicle 10.

According to the illustrated embodiment, the side member 42 has a substantially rectangular cross-section, in a transverse plane.

The lower end edge 38 of each longitudinal flange 34 is here fastened to the outer wall 40 of the side member 42 by means of a connecting plate 44. The connecting plate 44 is welded onto the outer face 40 of the side member 42 and each longitudinal flange 34 is welded onto the outer face of the connecting plate 44.

Advantageously, each longitudinal flange 34, 36 includes a window 45, here of rectangular shape, that extends along the cylindrical portion, or convex face 48, of the main axial wall 32.

The suspension support 24 also includes a front peripheral reinforcement wall 46 that is fastened on a front portion of the convex face 48 of the main axial wall 32 so as to form a front intermediate space 50 suitable for receiving a front pivot 52 for the upper suspension arm 16.

The front peripheral reinforcement wall 46 makes it possible to structurally reinforce the main axial wall 32 and therefore the suspension support 24, by providing greater rigidity to the assembly. This makes it possible to reach sufficient rigidity to support the front pivot 52.

The front peripheral reinforcement wall 46 has a general curved shape that follows the convex face 48 of the main axial wall 32.

The front intermediate space 50 opens to the outside, level with the window 45 formed in the front longitudinal flange 34.

The front peripheral reinforcement wall 46 includes, on the side of the front longitudinal flange 34, a fastening portion 54 that is bent toward the front relative to the remainder of the front peripheral reinforcement wall 46, so as to be able to be pressed against the front longitudinal flange 34 and welded onto the front longitudinal flange 34.

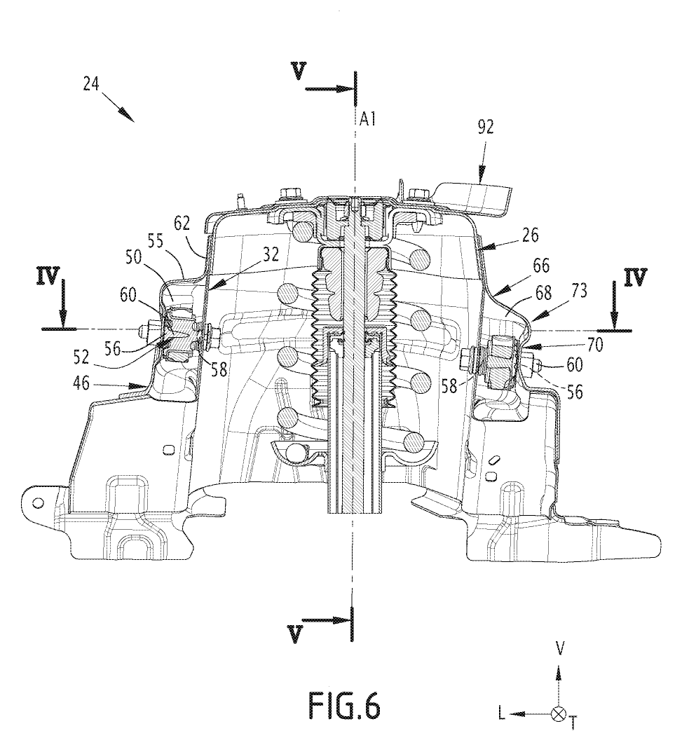

The front peripheral reinforcement wall 46 includes a front portion 55, adjacent to the front longitudinal flange 34, the profile of which, in an axial plane, has overall the shape of an omega or a hat, as illustrated in the axial sectional view shown in FIG. 6. This front portion 55 thus forms a bulge outside the main axial wall 32 that delimits the front intermediate space 50 between the main axial wall 32 and the front peripheral reinforcement wall 46.

The front peripheral reinforcement wall 46 thus forms, with the convex face 48 of the main axial wall 32, a double skin that separates at the front intermediate space 50 to receive the front pivot 52.

The front portion 55 of the front peripheral reinforcement wall 46 and the facing portion of the main axial wall 32 are each provided with a hole 56, 58 that makes it possible to fasten the front pivot 52 by means of a fastening screw 60 through both holes 56, 58.

Advantageously, the front portion 55 is flattened at the hole 56 concerned.

Note that the front peripheral reinforcement wall 46 includes an upper band 62 and a lower band 64, on either side of the front portion 55, which extend vertically in opposite directions and are pressed against the convex face 48 of the main axial wall 32.

The suspension support 24 includes a rear peripheral reinforcement wall 66 that is fastened on a rear portion of the convex face 48 of the main axial wall 32 so as to form a rear intermediate space 68 suitable for receiving a rear pivot 70 for the upper suspension arm 16.

The rear peripheral reinforcement wall 66 has a general shape similar to that of the front peripheral reinforcement wall 46, considering a transverse plane of symmetry passing through the axial suspension direction A1.

Thus, the rear peripheral reinforcement wall 66 includes, on the side of the rear longitudinal flange 36, a fastening portion 72 that is bent toward the rear relative to the remainder of the rear peripheral reinforcement wall 66, so as to be able to be pressed against the rear longitudinal flange 36 and welded onto the rear longitudinal flange 36.

The rear peripheral reinforcement wall 66 includes a rear portion 73, adjacent to the rear longitudinal flange 36, the profile of which, in an axial plane, has overall the shape of an omega or a hat, like the front peripheral reinforcement wall 46. This rear portion 73 thus forms a bulge outside the main axial wall 32 that delimits the rear intermediate space 68 between the main axial wall 32 and the rear peripheral reinforcement wall 66.

The rear portion 73 of the rear peripheral reinforcement wall 66 and the facing portion of the main axial wall 32 are each provided with a hole 56, 58 that makes it possible to fasten the rear pivot 70 by means of a fastening screw 60 through both holes 56, 58.

The rear intermediate space 68 opens to the outside level with the window 45 formed in the rear longitudinal flange 36.

The upper suspension arm 16 includes, on the inner side of the vehicle, a front branch 74 and a rear branch 76 that are pivotably mounted, by their free ends, on the suspension support 24 by means of the front pivot 52 and the rear pivot 70 respectively.

Thus, each branch 74, 76 of the upper suspension arm 16 passes through the associated window 45 and has its free end received in the associated intermediate space 50, 68.

Advantageously, the two peripheral reinforcement walls 46, 66 include an overlap portion 78 where one of the peripheral reinforcement walls 46, 66, here the front peripheral reinforcement wall 46, is fastened on the other peripheral reinforcement wall 46, 66, here the rear peripheral reinforcement wall 66.

Preferably, each peripheral reinforcement wall 46, 66 includes stiffening ribs 80 that extend circumferentially relative to the main axial wall 32.

Advantageously, a lateral reinforcement 82 is added and fastened, preferably by welding, against the outer lateral edge 84 of the cup 26.

The lateral reinforcement 82 is in the form of a cut and stamped sheet-metal plate including an inner axial wall portion 86 that matches the shape of the outer lateral edge 84 so as to be able to be pressed and welded onto said outer lateral edge 84.

In addition, the lateral reinforcement 82 includes two end wall portions 88, 90 arranged at the longitudinal ends of the inner axial wall portion 86, which are pressed and welded respectively onto the longitudinal flanges 34, 36 belonging to the main axial wall 32.

According to the illustrated embodiment, the lateral reinforcement 82 has overall an axial cross-sectional profile in the shape of an inverted U.

Advantageously, the suspension support 24 includes an upper reinforcement 92 in the form of a cut and stamped sheet-metal plate that covers the cup 26 and the lateral reinforcement 82.

The upper reinforcement 92 is welded onto the cup 26 and onto the lateral reinforcement 82.

The lateral reinforcement 82 includes a top wall 94 that is pressed and welded against the lower face 96 of the upper reinforcement 92.

The upper reinforcement 92 includes two lateral portions 102, 104 that extend transversely outward, on either side of the outer axial wall portion 98 of the lateral reinforcement 82, and that are welded to a side panel 106 of the body 12 of the vehicle 10.

According to the illustrated embodiment, the upper reinforcement 92 has overall the form of a transverse plate whose two lateral portions 102, 104 form a U.

The lateral reinforcement 82 here includes an outer axial wall portion 98 that is pressed and welded onto an outer axial wall portion 100 of the upper reinforcement 92.

The outer axial wall portion 98 of the lateral reinforcement 82 here forms an inward step in an outer edge of the lateral reinforcement 82. This step corresponds to the wall portion of the upper reinforcement 92 located between the two lateral portions 102, 104.

Preferably, the different components of the suspension support 24 are made from stamped sheet metal and then welded to one another and welded onto the vehicle structure 10.

Any feature described above for an embodiment or a variant is applicable to the other embodiments and variants, provided that it is technically possible.

What is claimed is:

1. A suspension support for a motor vehicle, the suspension support comprising:
a cup configured to fasten an upper end of a shock absorber along a main suspension axis;
a main semi-cylindrical axial wall that is capped by the cup;
a front peripheral reinforcement wall that is fastened on a front portion of a convex face of the main semi-cylindrical axial wall so as to form a front intermediate space configured to receive a front pivot for an upper suspension arm; and
a rear peripheral reinforcement wall that is fastened on a rear portion of the convex face of the main semi-cylindrical axial wall so as to form a rear intermediate space configured to receive a rear pivot for the upper suspension arm,
wherein the main semi-cylindrical axial wall comprises two opposite longitudinal flanges each provided with a window communicating with the associated intermediate space so as to allow an element of the upper suspension arm to pass through said window.

2. The suspension support according to claim 1, wherein each peripheral reinforcement wall comprises a fastening portion that is pressed against an inner face of the associated longitudinal flange of the main semi-cylindrical axial wall.

3. The suspension support according to claim 1, wherein the front and rear peripheral reinforcement walls comprise an overlap portion where one of the front and rear peripheral reinforcement walls is fastened on the other one of the front and rear peripheral reinforcement walls.

4. The suspension support according to claim 1, wherein each peripheral reinforcement wall comprises a portion whose profile, in an axial plane, has overall a shape of an omega, the associated intermediate space being formed inside the omega.

5. The suspension support according to claim 1, wherein each peripheral reinforcement wall comprises at least one stiffening rib that extends circumferentially relative to the main semi-cylindrical axial wall.

6. A motor-vehicle suspension system comprising:
the suspension support according to claim 1;
the upper suspension arm that comprises the front pivot mounted in the front intermediate space and the rear pivot mounted in the rear intermediate space, each pivot being held on one side on the peripheral reinforcement wall and on the other side on the main semi-cylindrical axial wall;
a lower suspension arm; and
the shock absorber whose upper end is fastened to the cup.

7. A motor vehicle comprising the motor-vehicle suspension system according to claim 6, wherein the main semi-cylindrical axial wall comprises the two opposite longitudinal flanges each provided with the window communicating with the associated intermediate space so as to allow the element of the upper suspension arm to pass through said window, and wherein a lower end edge of each longitudinal flange extends in a plane substantially flush with an outer wall of a side member of the motor vehicle.
